(19) United States
(12) Patent Application Publication
(10) Pub. No.: US 2013/0076976 A1
(43) Pub. Date: Mar. 28, 2013

(54) CAMERA MODULE

(71) Applicants: Sang Jin LEE, Gyunggi-do (KR); Ick Chan SHIM, Gyunggi-do (KR); Hong Sik YANG, Gyunggi-do (KR); Kum Sung JANG, Seoul (KR)

(72) Inventors: Sang Jin LEE, Gyunggi-do (KR); Ick Chan SHIM, Gyunggi-do (KR); Hong Sik YANG, Gyunggi-do (KR); Kum Sung JANG, Seoul (KR)

(73) Assignee: SAMSUNG ELECTRO-MECHANICS CO., LTD., Gyunggi-do (KR)

(21) Appl. No.: 13/427,817

(22) Filed: Mar. 22, 2012

(30) Foreign Application Priority Data
Sep. 23, 2011 (KR) 10-2011-0096273

(51) Int. Cl. H04N 5/225

(52) U.S. Cl. 348/374; 348/E05.024

(57) ABSTRACT

Disclosed herein is a camera module including: a lens barrel part in which a plurality of lenses are stacked; a housing enclosing an outer peripheral surface of the lens barrel part; an infrared (IR)-cut filter mounted at a lower portion of the housing to remove a near infrared wavelength; an image sensor mounted on a lower portion of the IR-cut filter to convert an external image into an electrical signal; a circuit board having an opening part formed at the center thereof, the opening part receiving the image sensor therein; and a plate mounted on the circuit board and made of a thermal conductive material so as to radiate heat generated from the circuit board.

### CROSS REFERENCE TO RELATED APPLICATION

This application claims the benefit of Korean Patent Application No. 10-2011-0096273, filed on Sep. 23, 2011, entitled “Camera Module”, which is hereby incorporated by reference in its entirety into this application.

### BACKGROUND OF THE INVENTION

1. Technical Field

The present relates to a camera module, and more particularly, to implementation of a slim camera module.

2. Description of the Related Art

As a mobile phone or a tablet personal computer (PC) has gradually become slim, a camera module has become slim. In this situation, there are some limitations in products that may be implemented by a component according to the prior art.

In order to manufacture a slim camera module under the same condition, a special package technology is required, which may be considered as a technology and market competitiveness of a company.

The camera module according to the prior art has been manufactured in a chip of board (COB) scheme that is currently implemented in many companies. That is, the camera module is configured to include a lens, a housing, a filter, a sensor, a circuit board, or the like.

This scheme has a limitation in implementing slimness of the camera module. Therefore, research into a structure for slimness of a camera module has been urgently demanded.

### SUMMARY OF THE INVENTION

The present invention has been made in an effort to provide a camera module capable of having a slim size and securing reliability.

According to a preferred embodiment of the present invention, there is provided a camera module including: a lens barrel part in which a plurality of lenses are stacked; a housing enclosing an outer peripheral surface of the lens barrel part; an infrared (IR)-cut filter mounted at a lower portion of the housing to remove a near infrared wavelength; an image sensor mounted on a lower portion of the IR-cut filter to convert an external image into an electrical signal; a circuit board having an opening part formed at the center thereof, the opening part receiving the image sensor therein; and a plate mounted on the circuit board to radiate heat generated from the circuit board.

The circuit board may have a thickness corresponding to that of the image sensor.

The camera module may further include a wire bonding part electrically connecting the image sensor and the circuit board to each other.

The plate may have a thickness thinner than that of the circuit board.

The plate may be made of a steel or copper material.

The plate may be made of a thermal conductive material.

### BRIEF DESCRIPTION OF THE DRAWINGS

FIG. 1 is an exploded view of a camera module according to a preferred embodiment of the present invention; and

FIG. 2 is a cross-sectional view of the camera module according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

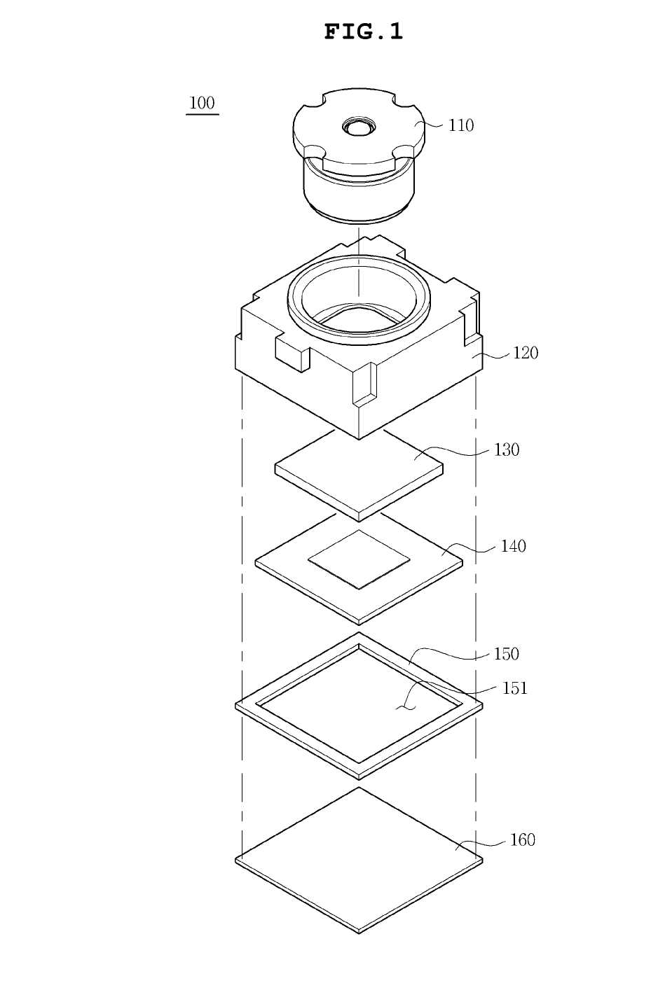

FIG. 1 is an exploded view of a camera module 100 according to a preferred embodiment of the present invention; and HG. 2 is a cross-sectional view of the camera module 100 according to the preferred embodiment of the present invention.

As shown in FIG. 1, the camera module 100 according to the preferred embodiment of the present invention, which may have a small and slim size and secure reliability against drops, or the like, is configured to include a lens barrel part 110, a housing 120, an infrared (IR)-cut filter 130, an image sensor 140, a circuit board 150, and a plate 160.

The lens barrel part 110 is configured of a plurality of lens embedded therein, collects images of a subject for photography on the image sensor 140 in the camera module 100, and is screw-coupled to the housing 120 by a screw thread formed on an outer peripheral surface thereof.

The housing 120 supports the entire lens barrel part 110 to protect the lens barrel part 110 from the outside and is fixedly coupled to the circuit board 150 to protect components such as the IR-cut filter 130 mounted on the circuit board 150.

Here, an inner peripheral surface of the housing 120 to which the lens barrel part 110 is coupled is provided with a screw groove engaged with the screw thread of the lens barrel part 110.

The IR-cut filter 130 is required in order to remove wavelengths in a near infrared range. More specifically, a camera of a camera phone generates an image by converting optical signals into electric signals using a charged coupled device (CCD) or a complementary metal oxide semiconductor (CMOS). These optical signals may be sensed in a near infrared region (˜1150 nm) as well as in a visible region (400 to 700 nm) that may be viewed by an eye of a person, such that a sensor is saturated with signals unrelated to an actual color or image. Therefore, the IR-cut filter is required to remove the wavelengths in a near infrared range.

The image sensor 140 converts external images into electrical signals and stores the converted electrical signals therein, instead of the existing film. The image sensor may be divided into a charged coupled device (CCD) image sensor and a CMOS image sensor (CIS). The CCD image sensor uses a charge coupled device. In addition, the CIS uses a complementary metal oxide semiconductor.

The CCD image sensor directly transmits a signal in an electron form, and the CIS transfers a signal in a voltage form. When the signal is transferred in the voltage form, the possibility that noise generated during a process of transferring the voltage signal or introduced from the outside will be mixed with the voltage signal to be introduced thereinto is high Therefore, the CCD image sensor using the electron signal is more robust to noise as compared to the CIS.

A ratio of an area occupied by a light receiving part in an area of one pixel is called a fill factor. Since a large amount of light may be received with respect to the same incident light as an area of the light receiving part becomes large, when the area of the light receiving part increases, the number of generated electrons also increases.

That is, the number of electronics used as the signal increases, such that sensitivity is improved and a magnitude of the signal becomes larger than noise, thereby being robust to the noise. Since the CIS includes a circuit for converting the electron into the voltage in a pixel, it has a fill factor lower than that of CCD image sensor. This indicates that the CCD image sensor is more excellent than the CIS in view of an image quality.

The CCD image sensor has a fill factor higher than that of the CIS and uses the electron as the signal to be robust to the noise. However, in the CCD image sensor, since a CMOS process that is currently mainly used may not be used and surrounding circuit parts may not be implemented on a chip, a manufacturing cost is increased and integration is decreased. In addition, the CCD image sensor uses a plurality of voltages, thereby consuming a large amount of power. On the other hand, the CIS drives the circuit using a single voltage and uses the CMOS, thereby making it possible to reduce power consumption.

The circuit board 150 is mounted at a lower portion of the housing 120 and includes an electrical circuit or various passive elements and integration circuits mounted thereon in order to transceive electrical signals.

The circuit board 150 includes an opening part 151 formed at the center thereof, wherein the opening part 151 includes the image sensor 140 mounted therein. According to the prior art, the image sensor 140 is mounted on the circuit board 150. However, according to the preferred embodiment of the present invention, the image sensor 140 is mounted in the opening part 151 formed at the center of the circuit board 150, such that the entire height of the camera module is reduced.

That is, since a total track length (TTL) (a distance from an upper end of the lens barrel part to an upper end of the image sensor) determining the entire height of the camera module is constant according to a pixel and a kind of camera, a scheme of reducing a length of the camera module without having an effect on the TTL is required.

Here, since the entire length of the camera module may be reduced when the length from an upper end of the image sensor 140 to a lower end of the circuit board 150 is reduced, the image sensor 140 is mounted in the central opening part 151 of the circuit board 150, thereby making it possible to significantly contribute to reducing the entire length of the camera module.

In addition, the circuit board 150 used in the preferred embodiment of the present invention has a thickness reduced by about 0.2 mm as compared to the ceramic substrate according to the prior art. That is, the circuit board 150 has a thickness of 0.2 mm, which corresponds to a general thickness of the image sensor 140.

For example, when it is assumed that TTL is 3.25 mm, the image sensor of the camera module according to the prior art has a thickness of 0.2 mm and the circuit board thereof has a thickness of 0.4 mm. Therefore, the camera module according to the prior art has a total height of 3.85 mm. Meanwhile, in the camera module according to the preferred embodiment of the present invention, a TTL is 3.25 mm, which is the same as the TTL of the camera module according to the prior art. In addition, the image sensor 140 is mounted in the circuit board 150, such that a total thickness of the image sensor 140 and the circuit board 150 is 0.2 mm, which is the same as the thickness of the image sensor of the camera module according to the prior art. Further, the plate 160 mounted on a lower portion of the circuit board 150 has a thickness of 0.1 mm. Therefore, the camera module according to the preferred embodiment of the present invention has a total height of 3.55 mm.

Therefore, the total height of the camera module according to the preferred embodiment of the present invention is reduced by 0.3 mm as compared to the total height of the camera module according to the prior art.

The plate 160, which is mounted on the lower portion of the circuit board 150, is fixed to the lower portion of the circuit board 150 to fix the image sensor 140 simultaneously with complementing strength of the circuit board 150.

That is, the plate complements the strength of the circuit board 150 having the strength reduced due to the thickness reduced as compared to the camera module according to the prior art as described above, thereby making it possible to contribute to reducing the thickness of the camera module.

In addition, since the plate 160 is mounted on the lower portion of the circuit board 150 and is robust to drops, impacts, or the like, reliability may be secured.

Meanwhile, the circuit board 150 mounted on an upper portion of the plate 160 generates heat while transceiving electrical signals. However, the plate 160 is made of a material having excellent thermal conductivity, thereby making it possible to excellently radiate the heat generated from the circuit board 150.

The plate 160 may be made of any material having excellent thermal conductivity and preferably, be made of a steel or copper material.

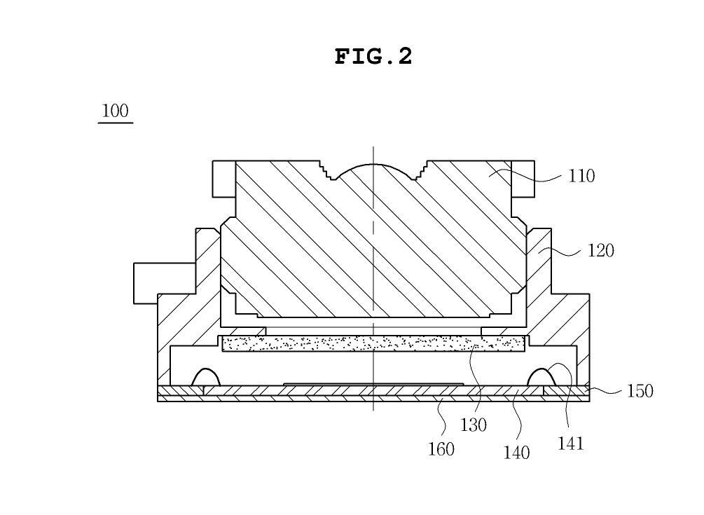

As shown in FIG. 2, the camera module 100 according to the preferred embodiment of the present invention has a shape in which the image sensor 140 is mounted in the central opening part of the circuit board 150 and the plate is mounted on the lower portion of the circuit board 150.

The image sensor 140 and the circuit board 150 are connected to each other by a wire bonding part 141. Since upper portions of the image sensor 140 and the circuit board 150 have the same height, the wire bonding part 141 has a length reduced as compared to the prior art.

Therefore, a raw material cost is reduced as compared to the prior art. In addition, the wire bonding part 141 is connected laterally, such that a space may be usefully used as compared to the prior art.

In the camera module 100 having the above-mentioned feature, the opening part 151 is formed at the center of the circuit board 150, the image sensor 140 is mounted in the opening part 151, the height of the camera module is reduced by the thickness of the circuit board 150, and the plate 160 is mounted on the lower portion of the circuit board 150 in order to complement the strength of the circuit board 150.

Through the above-mentioned structure, the plate 160 is mounted on the lower portion of the circuit board 150 and is robust to drops, impacts, or the like, thereby reducing a thickness of the camera module simultaneously with securing the reliability of the camera module. Therefore, it is possible to miniaturize the camera module.

In addition, the plate 160 is made of a thermal conductive material, thereby making it possible to excellently radiate heat generated when the circuit board 150 mounted on the upper portion of the plate 160 transceives the electrical signals.

The plate 160 is mounted on the lower portion of the camera module to treat electromagnetic interface (EMI), thereby making it possible to increase reliability of the camera module.

In addition, the image sensor 140 and the circuit board 150 are connected to each other by the wire bonding part 141. Since upper portions of the image sensor 140 and the circuit board 150 have the same height, the wire bonding part 141 has a length reduced as compared to the prior art.

Therefore, a raw material cost is reduced as compared to the prior art. In addition, the wire bonding part 141 is connected laterally, such that a space may be usefully used as compared to the prior art.

Although the embodiment of the present invention has been disclosed for illustrative purposes, it will be appreciated that a camera module according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A camera module comprising:
a lens barrel part in which a plurality of lenses are stacked;
a housing enclosing an outer peripheral surface of the lens barrel part;
an infrared (IR)-cut filter mounted at a lower portion of the housing to remove a near infrared wavelength;
an image sensor mounted on a lower portion of the IR-cut filter to convert an external image into an electrical signal;
a circuit board having an opening part formed at the center thereof, the opening part receiving the image sensor therein; and
a plate mounted on the circuit board to radiate heat generated from the circuit board.

2. The camera module as set forth in claim 1, wherein the circuit board has a thickness corresponding to that of the image sensor.

3. The camera module as set forth in claim 1, further comprising a wire bonding part electrically connecting the image sensor and the circuit board to each other.

4. The camera module as set forth in claim 1, wherein the plate has a thickness thinner than that of the circuit board.

5. The camera module as set forth in claim 1, wherein the plate is made of a steel or copper material.

6. The camera module as set forth in claim 1, wherein the plate is made of a thermal conductive material.
